(19) United States
(12) Patent Application Publication
(10) Pub. No.: US 2009/0302010 A1
(43) Pub. Date: Dec. 10, 2009

(54) Resistance welding method and welded structure

(75) Inventors: Akira Goto, Tochigi (JP); Toshiyuki Horimukai, Tochigi (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Tokyo (JP)

(21) Appl. No.: 12/454,668

(22) Filed: May 21, 2009

(30) Foreign Application Priority Data
Jun. 6, 2008 (JP) 2008-149645

(51) Int. Cl. B23K 11/00

(52) U.S. Cl. 219/117.1

(57) ABSTRACT

Two or more superposed plates and a thin plate are resistance-welded by: placing, on the two or more superposed plates, the thin plate whose thickness is less than each of the two or more superposed plates; placing a welding auxiliary member on the thin plate; making one of a pair of electrodes abut on the welding auxiliary member, and making the other of electrodes abut on a bottom surface of a lowest plate of the two or more superposed plates; and resistance-welding the two or more superposed plates and the thin plate to one another by the pair of electrodes.

### BACKGROUND OF THE INVENTION

1. Field of the Invention

The present invention relates to a method for resistance-welding two or more superposed plates and a thin plate, and also relates to a welded structure. More particularly, the invention relates to a resistance welding method for reliably resistance-welding two or more superposed plates to a thin plate, and also relates to a welded structure.

2. Background Art

A resistance welding method has been known, in which superposed metal plates are sandwiched between bar-like electrodes and a large current is fed thereto in a short time, while the metal plates are strongly pressurized, and in which metal is melted and then solidified on each contact surface between the metal plates so as to form a nugget, so that the superposed metal plates are welded together.

Patent Document 1 describes a resistance welding method for welding together a workpiece 106 constituted by first placing a thick plate 102 on a thick plate 100, and then placing on the thick plate 102 a thin plate 104 whose thickness is lower than those of the thick plates 100 and 102 (see FIG. 3A). According to the method disclosed in Patent Document 1, electric current is supplied to the works 106 between electrodes 108 and 110 from a power supply (not shown) while the works 106 are press-contacted with one another by the electrodes 108 and 110. Thus, a nugget is generated around the contact surface between the thick plates 100 and 102. Subsequent growth of the nugget results in the welding-together of the thick plates 100 and 102 and the thin plate 104.

Further, Patent Document 2 discloses a technical idea that a composite member 118 produced by interposing a resin member 116 between thin plates 112 and 114 is resistance-welded to a work 122 placed on a thick plate 120 (see FIG. 3B). According to the method disclosed in Patent document 2, a backing plate 124 having the same thickness as that of the thick plate 120 is placed on the thin plate 114. Then, an electrode 126 is made to abut on the backing plate 124. An electrode 128 is made to abut on the bottom surface of the thick plate 120. Then, electric current is fed between the electrodes 126 and 128. Consequently, the thick plate 120 is welded to the thin plates 112 and 114.
[Patent Document 1] JP-A-2003-251468
[Patent Document 2] JP-A-06-246462

A distal end portion of the electrode 108 usually used for welding disclosed in Patent Document 1 is cooled by coolant water circulating therein. Because a distance from the distal end portion of the electrode 108 to the contact surface between the thick plate 102 and the thin plate 104 is shorter in comparison with that from the distal end portion of the electrode 108 to the contact surface between the thick plates 100 and 102, sometimes, the growth of the nugget is hindered, so that the welding of the thick plate 102 and the thin plate 104 is insufficient. In a case where the thin plate 104 is press-contacted with the thick plate 102 by the electrode 108, substantially no gap is formed between the thick plate 102 and the thin plate 104. Thus, in a case where electric current flowing from the electrode 108 to an electrode 110 passes in the contact surface between the thick plate 102 and the thin plate 104, sometimes, the electric current is diffused, so that an electric current density is reduced, that the generation of Joule heat is suppressed, and that the welding of the thick plate 102 and the thin plate 104 is insufficient. In addition, according to Patent Document 1, the contact area between the distal end portion of the electrode 110 and the thick plate 100 is set to be larger than that between the distal end portion of the electrode 108 and the thin plate 104 in order to gradually reduce the electric current density and to uniformize the growth of the nugget. This causes necessity of preparing a plurality of electrodes 108 and 110, which differ from one another in distal end diameter, due to the relationship among the thicknesses of the thick plates 100 and 102 and the thin plate 104.

According to the welding method disclosed in Patent Document 2, the welding of the work 122 is performed using the backing plate 124. However, there is necessity of setting the thickness of the thick plate 120 to be equal to that of the backing plate 124 in order to uniformize pressures applied to the work by setting thicknesses of the plates arranged in an upward direction from the resin member 116 and those of the plates arranged in a downward direction therefrom to be symmetric with respect to the resin member 116. Thus, at each resistance welding, the backing plate 124 should be prepared according to the thickness of the thick plate 120. This complicates a resistance-welding process.

### SUMMARY OF THE INVENTION

One or more embodiments of the invention provide a resistance welding method for resistance-welding two or more superposed plates and a thin plate member, reliably as much as possible.

In accordance with one or more embodiments of the invention, a resistance welding method includes: placing, on two or more superposed plates 12, 14, a thin plate 16 whose thickness is less than each of the two or more superposed plates 12, 14; placing a welding auxiliary member 18 on the thin plate 16; making one 22 of a pair of electrodes 22, 28 abut on the welding auxiliary member 18, and making the other 28 of electrodes 22, 28 abut on a bottom surface 26 of a lowest plate 12 of the two or more superposed plates 12, 14; and resistance-welding the two or more superposed plates 12, 14 and the thin plate 16 to one another by the pair of electrodes 22, 28.

Consequently, an electric current density on a contact surface between the thin plate and one of the two or more superposed plates is increased to thereby promote a generation of Joule heat. Accordingly, the resistance welding of the thin plates and the two or more superposed plates can surely be achieved.

An area of a top surface 19 of the welding auxiliary member 18 may be equal to or less than an area of a distal end portion 24 of the one 22 of electrodes 22, 28 upon completion of resistance-welding of the two or more superposed plates 12, 14 and the thin plate 16. Consequently, the welding auxiliary member can be pressed into the thin plate. Accordingly, the resistance welding of the thin plate and the two or more superposed plates can be more surely achieved.

Moreover, in accordance with one or more embodiments of the invention, a welded structure is provided with: two or more superposed plates 12, 14; a thin plate 16 whose thickness is less than each of the two or more superposed plates 12, 14, in which the two or more superposed plates 12, 14 and the thin plate 16 placed on the two or more superposed plates 12, 14 are to be resistance-welded to one another; and a welding auxiliary member 18 in which at least a part of the welding auxiliary member 18 is placed on a dent 21 formed on the thin plate 16.

By placing at least a part of the welding auxiliary member on the dent formed on the thin plate, the electric current density on the contact surface of the thin plate and one of the two or more superposed plates can be increased. Thus, the generation of Joule heat can be promoted. Consequently, the resistance welding of the thin plate and the two or more superposed plates can surely be achieved. Further, the top surface of the thin plate is planarized. Thus, the coating quality of the welded structure can be enhanced. In addition, the appearance thereof can be maintained.

According to the resistance welding method and the welded structure of one or more embodiments of the invention, electric current is supplied between the electrodes by applying electric current to the thin plate and the two or more superposed plates via the welding auxiliary member. Thus, the temperature of the thin plate can be prevented from-being lowered. Further, the diffusion of electric current can be prevented. On the other hand, the electric current density on the contact surface between the thin plate and one of the two or more superposed plates is enhanced. Thus, the generation of Joule heat can be promoted. Consequently, the resistance welding of the thin plate and the two or more superposed plates can surely be implemented. Further, the top surface of the thin plate is planarized. Thus, the coating quality of the welded structure can be enhanced. In addition, the appearance of the welded structure can be maintained.

Other aspects and advantages of the invention will be apparent from the following description, the drawings and the claims.

### BRIEF DESCRIPTION OF THE DRAWINGS

FIGS. 1A to 1E are explanatory views respectively illustrating steps of a process of obtaining a welded structure by a resistance welding method according to an embodiment of the invention.

FIG. 2A is a schematic perspective view illustrating a welded structure according to the embodiment of the invention.

FIG. 2B is a cross-sectional view taken along line IIB-IIB illustrated in FIG. 2A.

FIGS. 3A and 3B are explanatory views respectively illustrating conventional resistance welding methods for obtaining welded structures by resistance-welding.

### DETAILED DESCRIPTION OF THE EXEMPLARY EMBODIMENTS

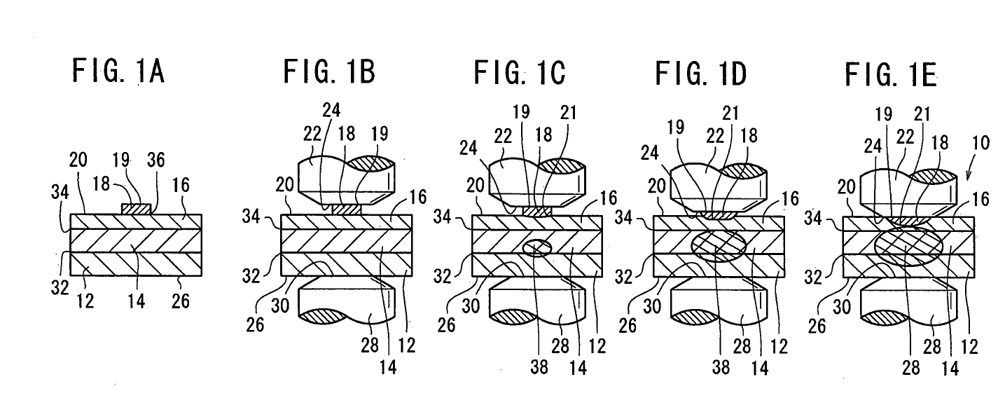

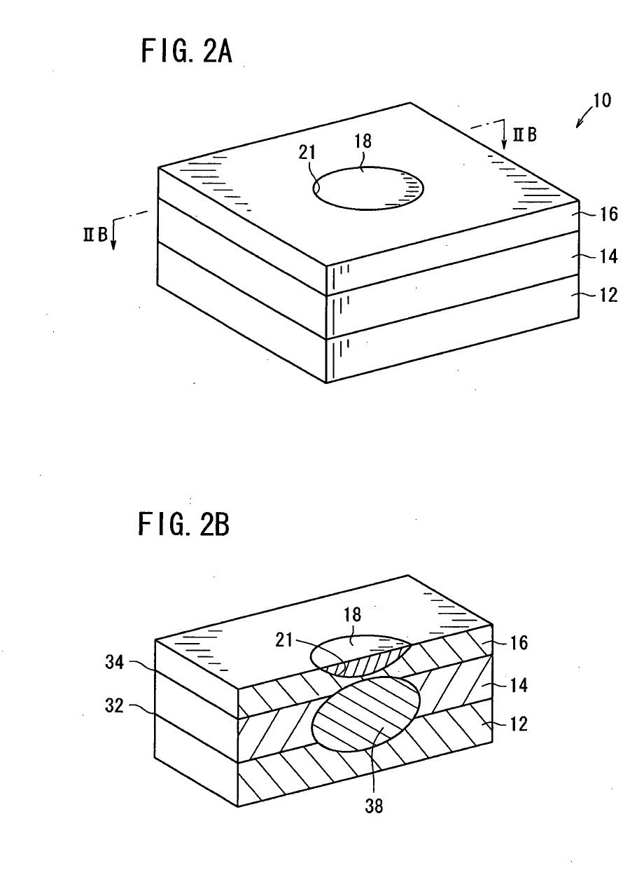

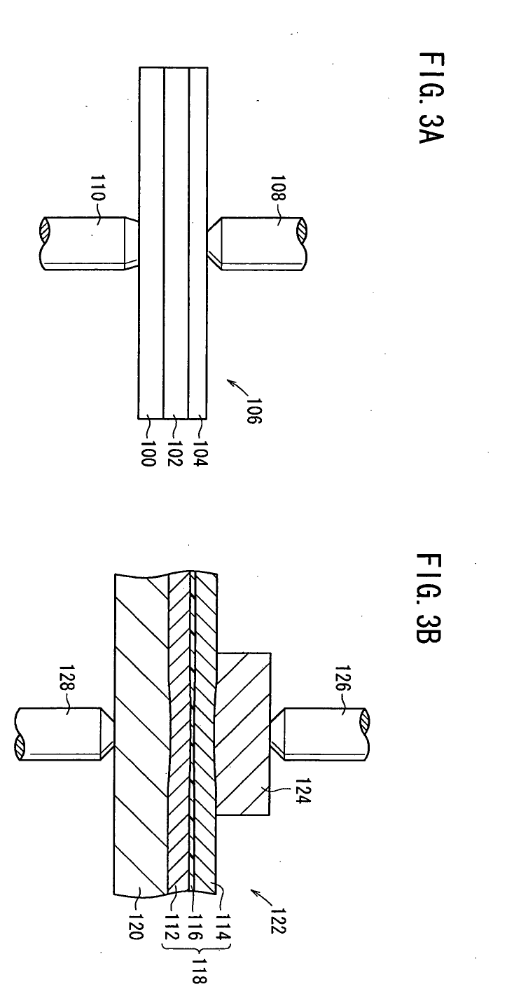

Hereinafter, an exemplary embodiment of the invention is described in detail with reference to the accompanying drawings. FIGS. 1A to 1E are explanatory views respectively illustrating steps of a process of obtaining a welded structure 10 by a resistance welding method according to the present embodiment of the invention. FIG. 2A is a schematic perspective view illustrating the welded structure 10. FIG. 2B is a cross-sectional view taken along line IIB-IIB illustrated in FIG. 2A.

According to the present embodiment, when resistance welding is performed to obtain the welded structure 10, first, a thin plate 16 is placed on superposed thick plates 12 and 14. Then, a welding auxiliary member 18 for promoting the resistance welding of the thick plate 14 and the thin plate 16 is placed on the top surface 20 of the thin plate 16 (see FIG. 1A).

The material of the thick plates 12 and 14 is not limited to a specific material. However, preferably, this material is, e.g., a high-tensile strength steel. The thickness of the thin plate 16 is set to be less than that of each of the thick plates 12 and 14. Preferably, the thickness of the thin plate 16 is about half that of each of the thick plates 12 and 14. Further, the materials of the thin plate 16 and the welding auxiliary member 18 are not limited to specific materials. However, preferably, the material of the thin plate 16 and the welding auxiliary member 18 is mild steel. A method for placing the welding auxiliary member 18 on the thin plate 16 is not limited to that of simply placing a plate on the thin plate 16. For example, a plate can be welded onto the thin plate 16 by arc-welding, plasma-welding, or laser-welding, using a filler wire. Alternatively, a specific material can be fixed to the thin plate 16 by thermal spraying, or cold spraying. Sometimes, the area of the top surface 19 of the welding auxiliary member 18 is reduced by pulling the welding auxiliary member 18 into a dent 21 formed in the thin plate 16 when the welding auxiliary member 18 is press-into the thin plate 16. That is, although the area of the top surface 19 at the time of placing the welding auxiliary member 18 on the thin plate 16 can be either larger or smaller than that of a distal end portion 24 of the electrode (i.e., one of the electrodes) 22, the area of the top surface 19 at completion of the resistance welding is determined to be equal to or less than the area of the distal end portion 24.

Next, the distal end portion 24 of the electrode 22 is made to abut on the welding auxiliary member 18. Further, the distal end portion 30 of the electrode (i.e., the other electrode) 28 is made to abut on the bottom surface 26 of the thick plate 12, on which the thin plate 16 is not placed (see FIG. 1B). Next, the electrodes 22 and 28 are pressed in a direction in which the electrodes 22 and 28 come closer to each other. In addition, electric current is supplied to the electrodes 22 and 28 from a power supply (not shown). Thus, electric current is applied to the welding auxiliary member 18, the thin plate 16 and the thick plates 14 and 12 in this order in a direction from the electrode 22 to the electrode 28.

Coolant water is circulated in the inside of the electrode 22. Thus, the cooling effect of this coolant water is transmitted to the thin plate 16 via the welding auxiliary member 18. The shorter the distance from the top surface 24 of the thin plate 16 to a contact surface becomes, the temperature of the contact surface is more lowered. Accordingly, the contact surfaces in the ascending order of temperature are the contact surface 36 between the top surface 20 of the thin plate 16 and the welding auxiliary member 18, the contact surface 34 between the thick plate 14 and the thin plate 16, and the contact surface 32 between the thick plates 12 and 14. Therefore, the generation of a nugget 38 is started from the vicinity of the contact surface 32 (see FIG. 1C). Further, the pressing of the welding auxiliary member 18 into the thin plate 16 is started by the pushing force of the electrode 22. That is, the welding auxiliary member 18 can be pressed into the thin plate 16.

In a case where the pressing and the supply of electric current by the electrodes 22 and 28 are further continued, the nugget 38 grows to the contact surface 34. Simultaneously, the pressing of the welding auxiliary member 18 into the thin plate 16 progresses (see FIG. 1D).

In a case where the pressing and the supply of electric current by the electrodes 22 and 28 are continued for a predetermined time, the nugget 38 grows into the thin plate 16 over the contact surface 34. Consequently, the thick plates 12 and 14 and the thin plate 16 are integrated with one another. Thus, the resistance welding thereof is completed (see FIG. 1E). Then, the electrode 22 is separated from the welding auxiliary member 18. The electrode 28 is separated from the bottom surface 26 of the thick plate 12. Thus, the welded structure 10 is obtained (see FIG. 2A).

According to the present embodiment, in the resistance welding process of obtaining the welded structure 10, the distal end portion 24 of the electrode 22 is made to abut on the welding auxiliary member 18 without being made to abut directly on the thin plate 16. Thus, the distal end portion 24 and the contact surface 34 are separated from each other by a total of the thickness of the thin plate 16 and the thickness of the welding auxiliary member 18. Consequently, the cooling effect of cooling the contact surface 34 by the coolant water circulating in the electrode 22 is mitigated. Accordingly, the growth of the nugget 38, which is started from the vicinity of the contact surface 32, can be continued without being blocked by the contact surface 34. Thus, the resistance welding of the thick plate 14 and the thin plate 16 can surely be achieved.

Further, the supply of electric current from the electrode 22 to the thin plate 16 is performed via the welding auxiliary member 18 the area of which is less than that of the distal end portion 24 of the electrode 22. Consequently, the diffusion of electric current can be prevented. Further, the generation of Joule heat is promoted by increasing the electric current density of the contact surface 34. Accordingly, the resistance welding of the thick plate 14 and the thin plate 16 can surely be achieved (see FIG. 2B).

Incidentally, in the present embodiment, the two thick plates, i.e., the thick plates 12 and 14 are superposed. However, the number of thick plates is not limited to a specific value. Three or more thick plates can be superposed. In such a case, the electrode 28 is made to abut on the lowest thick plate.

In consideration of the facts that when the welding auxiliary member 18 is placed on the thin plate 16, the welding auxiliary member 18 is pressed into the thin plate 16 and is pulled into the dent 21 and is shrank, the area of the top surface 19 of the welding auxiliary member 18 is determined, and the welding auxiliary member 18 is pressed into the thin plate 16 by the electrode 22. Thus, upon completion of the resistance welding, the welding auxiliary member 18 is pressed into the thin plate 16. Further, the top surface 20 of the thin plate 16 is planarized. Consequently, the coating quality of the welded structure can be enhanced. In addition, the appearance of the welded structure can be maintained.

As illustrated in FIG. 2B, the welding auxiliary member 18 is neither melted nor solidified. However, the thickness and the material of the welding auxiliary member 18 can be selected as those of the thin plate 16. Consequently, the nugget 38 can be made to grow over the contact surface 36. Thus, the thin plate 16 can be welded to the welding auxiliary member 18. Accordingly, the welding auxiliary member 18 can surely be prevented by welding the thin plate 16 to the welding auxiliary member 18 from being broken away from the thin plate 16.

While description has been made in connection with specific exemplary embodiment of the invention, it will be obvious to those skilled in the art that various changes and modification maybe made therein without departing from the present invention. It is aimed, therefore, to cover in the appended claims all such changes and modifications falling within the true spirit and scope of the present invention.

### Description of Reference Numerals and Signs

10 welded structure
12, 14, 100, 102, 120 thick plates
16, 104, 112, 114 thin plates
18 welding auxiliary member
19, 20 top surfaces
21 dent
22, 28, 108, 110, 126, 128 electrodes
24, 30 end portions
26 bottom surface
32, 34, 36contact surfaces
38 nugget
106, 122 works
116 resin member
118 composite member
124 backing plate

What is claimed is:

1. A resistance welding method comprising:
placing, on two or more superposed plates, a thin plate whose thickness is less than each of the two or more superposed plates;
placing a welding auxiliary member on the thin plate;
making one of a pair of electrodes abut on the welding auxiliary member, and making the other of electrodes abut on a bottom surface of a lowest plate of the two or more superposed plates; and
resistance-welding the two or more superposed plates and the thin plate to one another by the pair of electrodes.

2. The resistance welding method according to claim 1, wherein an area of a top surface of the welding auxiliary member is equal to or less than an area of a distal end portion of the one of electrodes upon completion of resistance-welding of the two or more superposed plates and the thin plate.

3. A welded structure comprising:
two or more superposed plates;
a thin plate whose thickness is less than each of the two or more superposed plates, wherein the two or more superposed plates and the thin plate placed on the two or more superposed plates are to be resistance-welded to one another; and
a welding auxiliary member, wherein at least a part of the welding auxiliary member is placed on a dent formed on the thin plate.
